(19) United States
(12) Patent Application Publication
(10) Pub. No.: US 2025/0347034 A1
(43) Pub. Date: Nov. 13, 2025

(54) SYSTEMS AND METHODS FOR CONTROLLING CLOSED DIE TOOLING MOVEMENT DURING HEAT TREATMENT OF FIBEROUS PREFORM

(71) Applicant: GOODRICH CORPORATION, Charlotte, NC (US)

(72) Inventor: Kyle Rosenbrock, Pueblo, CO (US)

(73) Assignee: GOODRICH CORPORATION, Charlotte, NC (US)

(21) Appl. No.: 18/661,022

(22) Filed: May 10, 2024

(51) Int. Cl. D01F 9/22; C01B 32/05; D01F 9/32

(52) U.S. Cl. CPC D01F 9/225; C01B 32/05; D01F 9/328

(57) ABSTRACT

A heat treatment tooling fixture arrangement includes a male die and a female die. The female die includes a plurality of alignment surfaces and the male die includes a plurality of alignment rods configured to ride along the alignment surfaces to control motion of the male die with respect to the female die along two orthogonal directions (e.g., longitudinally and vertically). As an OPF preform shrinks during heat treatment (e.g., carbonization), the male die can move along a first axis toward the female die and can simultaneously move along a second axis along the female die to maintain compressive forces on the OPF preform.

### FIELD

The present disclosure relates to carbon/carbon composites, and more specifically, to systems and methods for manufacturing carbon/carbon (C/C) composites.

### BACKGROUND

Composite bodies are utilized in various industries, including the aerospace industry. C/C composites are often produced as 2D structures, for example utilizing planar oxidized polyacrylonitrile (PAN) fiber-based preforms followed by carbonization and chemical vapor infiltration (CVI) densification.

### SUMMARY

According to various embodiments, a method for manufacturing a C/C part is disclosed, the method includes positioning a fibrous preform with a female die, the female die comprising a die recess extending longitudinally between and to a first end of the female die and a second end of the female die and extending laterally between and to a first sidewall of the female die and a second sidewall of the female die. The method further includes positioning a male die at least partially in the die recess so that the fibrous preform is positioned between the male die and the female die. The method further includes positioning a first alignment rod extending from a first side of the male die with respect to a first alignment surface of the female die. The method further includes positioning a second alignment rod extending from a second side of the male die with respect to a second alignment surface of the female die. The method further includes performing a heat treatment process on the fibrous preform while the fibrous preform is positioned between the male die and the female die. The method further includes guiding the male die during the heat treatment process to move in a longitudinal direction and a second direction with respect to the female die using the first alignment rod and the first alignment surface and further using the second alignment rod and the second alignment surface, the second direction is perpendicular to the longitudinal direction and perpendicular to a lateral direction.

These and other embodiments can include one or more of the following features.

In various embodiments, the fibrous preform comprises an oxidized PAN fiber preform.

In various embodiments, the first alignment surface is disposed in the first sidewall of the female die and the second alignment surface is disposed in the second sidewall of the female die.

In various embodiments, the first alignment surface is disposed at a top side of the first sidewall and the second alignment surface is disposed at a top side of the second sidewall.

In various embodiments, the male die is configured to move simultaneously in both the longitudinal direction and the second direction in response to the first alignment rod moving along the first alignment surface.

In various embodiments, a first corner of the male die is aligned with a second corner of the female die in response to the first alignment rod moving along the first alignment surface.

In various embodiments, the die recess is at least partially defined by a first surface oriented at a non-parallel angle with respect to a second surface, the second corner of the female die is defined at an interface between the first surface and the second surface, and the second corner extends laterally between the first sidewall and the second sidewall.

In various embodiments, the method further includes decreasing a gap between the first sidewall and the male die in response to the male die moving in the longitudinal direction with respect to the female die, wherein the female die comprises a tapered geometry.

In various embodiments, the heat treatment process is a carbonization process.

In another aspect, a heat treatment tooling fixture arrangement is disclosed. The heat treatment tooling fixture arrangement includes a female die comprising a first sidewall, a second sidewall, a first alignment surface disposed in the first sidewall, a second alignment surface disposed in the second sidewall, and a die recess disposed between the first sidewall and the second sidewall. The heat treatment tooling fixture arrangement further includes a male die comprising a first alignment rod extending from a first side thereof and a second alignment rod extending from a second side thereof, the male die is configured to be received at least partially within the die recess. The first and second alignment rods are configured to contact, and move along, the first alignment surface and the second alignment surface, respectively, to control movement of the male die along a first axis and along a second axis so as to apply a compressive force to a fibrous preform located between the male die and the female die during a heat treatment process.

These and other embodiments can include one or more of the following features.

In various embodiments, the first alignment surface and the second alignment surface are configured to control movement of the male die simultaneously along the first axis and along the second axis.

In various embodiments, the first alignment surface is disposed at a top side of the first sidewall and the second alignment surface is disposed at a top side of the second sidewall.

In various embodiments, a first corner of the male die is configured to move toward a second corner of the female die in response to the first alignment rod moving along the first alignment surface.

In various embodiments, the die recess is at least partially defined by a first surface oriented at a non-parallel angle with respect to a second surface, the second corner of the female die is defined at an interface between the first surface and the second surface, and the second corner extends laterally between the first sidewall and the second sidewall.

In various embodiments, the male die comprises a wedge, a first plug, and a second plug, the first alignment rod extends from the first plug, and the second alignment rod extends from the second plug.

In various embodiments, the female die and the male forming die each comprise a tapered geometry.

In another aspect, a method for controlling closed die tooling movement during heat treatment of a fibrous preform is disclosed. The method includes positioning a male die at least partially in a die recess of a female die, the die recess extending longitudinally between and to a first end of the female die and a second end of the female die and extending laterally between and to a first sidewall of the female die and a second sidewall of the female die. The method further includes positioning a first alignment rod extending from a first side of the male die in contact with a first alignment surface of the female die. The method further includes positioning a second alignment rod extending from a second side of the male die in contact with a second alignment surface of the female die. The method further includes guiding the male die to move in a longitudinal direction and a second direction with respect to the female die using the first alignment rod and the first alignment surface and further using the second alignment rod and the second alignment surface.

These and other embodiments can include one or more of the following features.

In various embodiments, the method further includes applying a force to the male die in the second direction.

In various embodiments, the second direction is perpendicular to the longitudinal direction, the second direction is perpendicular to a lateral direction.

In various embodiments, the first alignment surface is oriented at a non-parallel angle with respect to the longitudinal direction.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

FIG. 1 is an assembly view of a carbonization tooling fixture arrangement, in accordance with various embodiments;

FIG. 2A and FIG. 2B are side views of the carbonization tooling fixture arrangement with the male die in a first position (e.g., at the beginning of a carbonization process) and a second position (e.g., at the end of the carbonization process), respectively, in accordance with various embodiments;

FIG. 3 is a perspective illustration of a female die, in accordance with various embodiments;

FIG. 4 is a perspective illustration of a male die, in accordance with various embodiments;

FIG. 5 is a front view of the carbonization tooling fixture arrangement with a fibrous preform installed therein, in accordance with various embodiments;

FIG. 6 is a flow diagram of a method for carbonization compression of a fibrous preform, in accordance with various embodiments;

FIG. 7 is a front view of a carbonization tooling fixture arrangement with a fibrous preform installed therein and having a male die formed as a multi-piece wedge and plug arrangement, in accordance with various embodiments;

FIG. 8 is a top view of a carbonization tooling fixture arrangement having a tapered profile, in accordance with various embodiments; and

FIG. 9 is a schematic view of a carbonization tooling fixture arrangement where the positions of the alignment rods and the alignment surfaces are swapped in comparison to the carbonization tooling fixture arrangement of FIG. 1, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, the term “fiber density” is used with its common technical meaning with units of g/cm³ or g/cc. The fiber density may refer specifically to that of the individual fibers in the fibrous preform. The density will be measured, unless otherwise noted, by taking the weight divided by the geometric volume of each fiber. The density may refer to an average density of a plurality of fibers included in a fibrous preform.

As used herein, “CVI/CVD” may refer to chemical vapor infiltration and/or chemical vapor deposition. Accordingly, CVI/CVD may refer to chemical vapor infiltration or deposition or both.

As used herein, where values and ranges are defined, for temperature and time, the term “about” means +/−100° C. and +/−24 hours.

In general, there are several methods of manufacturing carbon/carbon (“C/C”) materials depending on the part geometries and the end application performance requirements. In some of these methods, the process involves starting with a dry fibrous preform comprised of oxidized polyacrylonitrile (PAN) fiber, or OPF, followed by carbonization to convert the OPF into carbon fibers to produce a carbon fiber preform. This is subsequently followed by densification, wherein the spaces between the fibers in the preform are filled via resin infiltration and pyrolysis and/or chemical vapor infiltration to produce a carbon-fiber reinforced carbon matrix composite, or C/C composite material.

After a fibrous OPF preform (also referred to herein as a fibrous preform) is made, it is carbonized to convert the OPF into carbon fibers. Typically, fibrous preforms are carbonized by placing the preforms in a furnace with an inert atmosphere. As is well-understood, the heat of the furnace causes a chemical conversion which drives off the non-carbon chemical species from the preform. The resulting preform generally has the same fibrous structure as the fibrous preform before carbonizing. However, the OPF have been converted to 100%, or nearly 100%, carbon. After the preform has been carbonized, the preform is densified. In general, densification involves filling the voids, or pores, of the fibrous preform with additional carbon material. This may be done using the same furnace used for carbonization or a different furnace. Typically, chemical vapor infiltration and deposition (“CVI/CVD”) techniques are used to densify the porous fibrous preform with a carbon matrix. This commonly involves heating the furnace and the carbonized preforms, and flowing hydrocarbon gases into the furnace and around and through the fibrous preforms. As a result, carbon from the hydrocarbon gases separates from the gases and is deposited on and within the fibrous preforms. When the densification step is completed, the resulting C/C part has a carbon fiber structure with a carbon matrix infiltrating the fiber structure, thereby deriving the name “carbon/carbon”.

C/C parts of the present disclosure are formed using OPF fabrics that are shape-formed prior to carbonization. C/C parts of the present disclosure may be formed using multi-axial, non-crimp, stich-bonded, needled, OPF fabrics that are shape-formed prior to carbonization. C/C parts of the present disclosure may be particularly useful for high temperature aerospace applications, such as for re-entry vehicle applications or other high temperature applications such as where a hot gas impinges on the vehicle after being rapidly compressed and heated as a result of a high pressure bow shock in front of the vehicle. C/C parts of the present disclosure may be especially useful in these applications because of the superior high temperature characteristics of C/C material. In particular, the carbon/carbon material used in C/C parts is a good conductor of heat and is able to dissipate heat generated during high temperature conditions. Carbon/carbon material is also highly resistant to heat damage, and thus, may be capable of sustaining forces during severe conditions without mechanical failure.

Application of OPF-based carbon-carbon composites has been generally limited to simple flat structures including C/C aircraft brake disks. C/C components including leading edges, structural members, and other contour-shape carbon composites are often produced as 2D structures (i.e., flat, planar components); however, these materials tend to maintain low interlaminar properties. A shape formed 3D C/C part offers opportunity for similar in-plane C/C properties with higher interlaminar properties than 2D C/C.

Systems, apparatus, and methods of the present disclosure seek to maintain compressive forces on a shape-formed preform during heat treatment (e.g., carbonization) while minimizing and/or eliminating wrinkling and/or dimpling of the resulting part. A heat treatment tooling fixture arrangement includes a male die and a female die. The female die includes alignment surfaces which guide alignment rods of the male die to translate both longitudinally and vertically during the carbonization process.

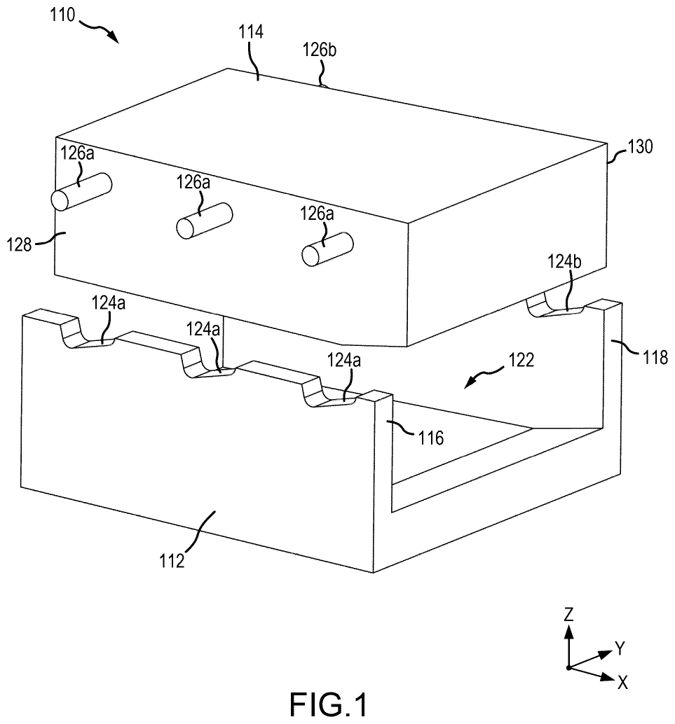

With reference to FIG. 1, a heat treatment tooling fixture arrangement 110 (also referred to herein as a carbonization tooling fixture arrangement) for compressing and shaping a fibrous preform during carbonization is illustrated, in accordance with various embodiments. The carbonization tooling fixture arrangement 110 can be a closed-die tool. The carbonization tooling fixture arrangement 110 can be used for carbonization compression (i.e., compression during the carbonization process). The carbonization tooling fixture arrangement 110 can include a female die 112 and a male die 114.

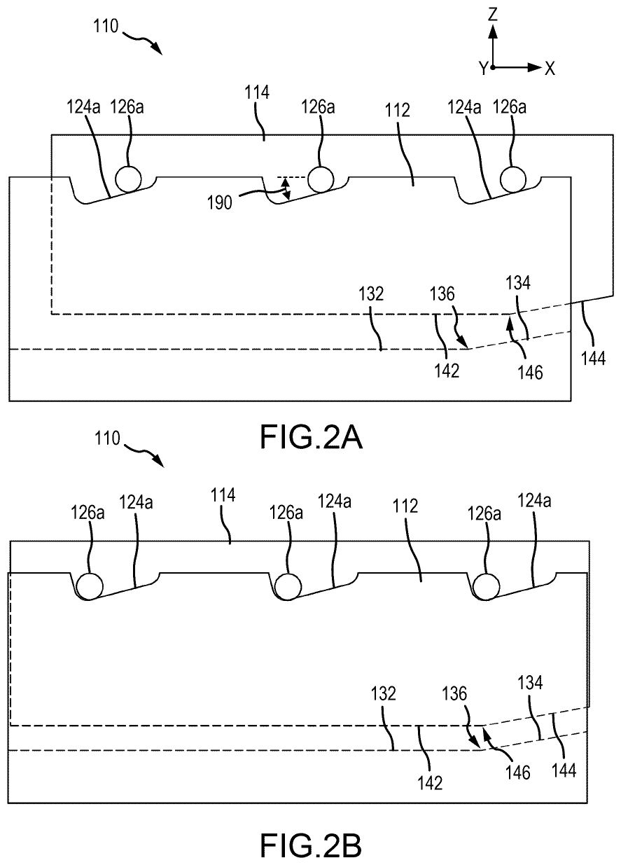

With combined reference to FIG. 1 and FIG. 2, the female die 112 is configured with at least one die recess 122 configured to receive the male die 114. The at least one die recess 122 is configured to receive a fibrous preform between the male die 114 and the female die 112.

The female die 112 includes a first sidewall 116 and a second sidewall 118. The die recess 122 extends laterally between and to the first sidewall 116 and the second sidewall 118. The female die 112 includes one or more alignment surfaces 124a disposed in the first sidewall 116 and one or more alignment surfaces 124b disposed in the second sidewall 118. The alignment surfaces 124a, 124b are referred to herein generally as alignment surfaces 124.

The male die 114 includes one or more alignment rods 126a extending from a first side 128 thereof and one or more alignment rods 126b extending from a second side 130 thereof. The alignment rods 126a, 126b are referred to generally as alignment rods 126.

The alignment rods 126 can be configured to rest against the alignment surfaces 124 during the carbonization process. The male die 114 can be supported by the alignment rods 126. In this manner, the alignment surfaces 124 can be configured to guide the male die 114 during the carbonization process. The alignment rods 126 can slide against the alignment surfaces 124. The alignment rods 126 can roll along the alignment surface 124. The alignment surfaces 124 can extend along the longitudinal direction (i.e., the X-axis in FIG. 1) and be angled with respect to the longitudinal direction. Accordingly, the alignment surfaces 124 can guide the male die 114 during the carbonization process to move in the longitudinal direction (i.e., the negative X-direction) and a Z-direction (i.e., the negative Z-direction)—which can be the vertical direction—with respect to the female die 112. The carbonization tooling fixture arrangement 110 design provides enough flexibility to maintain pressure application on the fibrous preform 120 as the thickness of the material decreases during the carbonization compression process.

With reference to FIG. 2A and FIG. 2B, the male die 114 is illustrated in a first position (e.g., at the beginning of a carbonization process) and a second position (e.g., at the end of the carbonization process), respectively, with respect to the female die 112. Each alignment surfaces 124 can be oriented at an angle 190 with respect to the longitudinal direction. In this manner, as the fibrous preform shrinks during carbonization, the male die 114 can move longitudinally and vertically with respect to the female die 112. In this manner, the male die 114 moves along multiple axes (i.e., along the X-axis and the Z-axis) during the carbonization process. The angle 190 can be between one degrees and eighty-nine degrees in various embodiments, between five degrees and twenty-five degrees in various embodiments, or between ten degrees and twenty degrees in various embodiments.

Controlling movement of the male die 114 with respect to the female die 112 along multiple axes can be particularly useful for carbonization of multi-contoured components. For example, the female die 112 can include one or more surfaces, such as a first surface 132 and a second surface 134, oriented at non-parallel angles with respect to one another and at least partially defining the die recess 122. A corner 136 can be defined between the first surface 132 and the second surface 134. The male die 114 can define a forming surface having a shape that is complementary to the shape of the first surface 132 and the second surface 134. For example, the male die 114 can include one or more surfaces, such as a first surface 142 and a second surface 144, oriented at non-parallel angles with respect to one another. A corner 146 can be defined between the first surface 142 and the second surface 144. Guiding the male die 114 to slide with respect to the female die 112 along the longitudinal direction (in addition to moving in the negative Z-direction) prevents unwanted wrinkling or impressions of the fibrous preform, particularly around the corners 136, 146. For example, without the longitudinal sliding of the male die 114 during the shrinking process, unwanted impressions of the corner 146 can be formed into the carbonized component.

In various embodiments, the corner 146 of the male die 114 can be moved longitudinally toward the corner 136 of the female die 112 as the alignment rods 126 translate along the alignment surfaces 124. Stated differently, the corner 146 of the male die 114 can be aligned with the corner 136 of the female die 112 as the alignment rods 126 translate along the alignment surfaces 124.

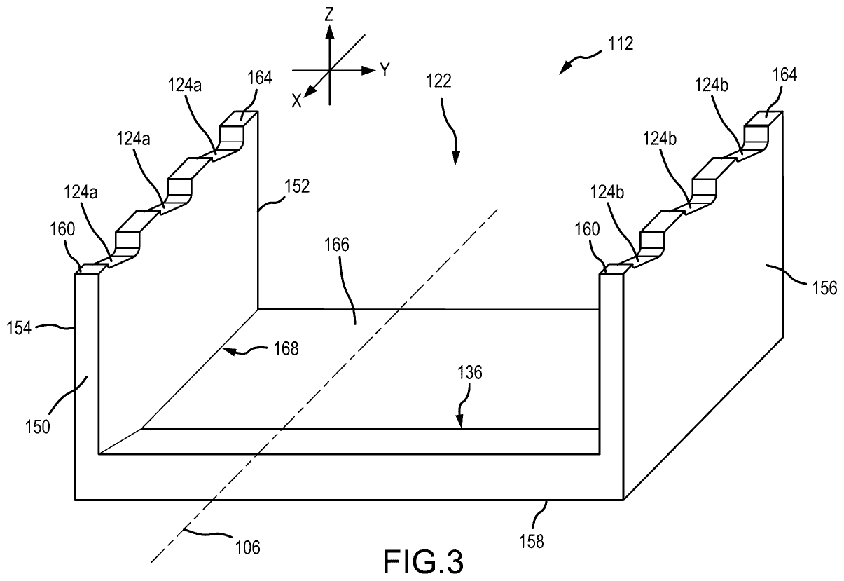

With reference to FIG. 3, the female die 112 extends longitudinally along a longitudinal centerline 106 of the female die 112 (e.g., along the X-axis) between and to a first end 150 of the female die 112 and a second end 152 of the female die 112. The female die 112 extends laterally (e.g., along a Y-axis) between and to a first side 154 of the female die 112 and a second side 156 of the female die 112. The female die 112 extends vertically (e.g., along a Z-axis) between and to a bottom side 158 of the female die 112 and a top side 160 of the female die 112.

The female die 112 is configured with at least one die recess 122; e.g., an aperture such as a pocket, a channel, a groove, etc. The die recess 122 of FIG. 3 extends (e.g., partially) vertically into the female die 112 from one or more top surfaces 164 of the female die 112 to a recess surface 166 of the female die 112, where the top surfaces 164 of FIG. 3 are arranged on opposing sides of the recess surface 166 at the female die top side 160. The die recess 122 of FIG. 3 extends longitudinally in (e.g., through) the female die 112, for example, between and to the female die first end 150 and/or the female die second end 152. The die recess 122 of FIG. 3 extends laterally in (e.g., within) the female die 112, for example, between opposing lateral sides of the recess surface 166.

The alignment surfaces 124 can be formed at the top side 160. The alignment surfaces 124 can be formed into the top surfaces 164 of the female die 112. The alignment surfaces 124 can form an elongated groove extending longitudinally along the top side 160 of the female die 112. The alignment surfaces 124 can be angled down toward the bottom of the die recess 122. Each alignment surface 124 can be spaced apart from an adjacent alignment surface 124.

The recess surface 166 can be a concave or concave-convex surface and may have a curved geometry; e.g., a three-dimensional (3D) curvature. The recess surface 166 of FIG. 3, for example, can have a curved (e.g., arcuate, splined, etc.) cross-sectional geometry in a lateral-vertical reference plane; e.g., a Y-Z plane. The recess surface 166 of FIG. 3 can also have a curved (e.g., arcuate, splined, etc.) cross-sectional geometry in a longitudinal-vertical reference plane; e.g., a X-Z plane. This recess curvature may change as the recess surface 166/the die recess 122 extends laterally and/or longitudinally, which may provide the recess surface 166 with a complex 3D curvature. In embodiments, the recess curvature may remain uniform as the recess surface 166/the die recess 122 extends laterally and/or longitudinally.

The recess surface 166 may be configured with one or more laterally extending corners 136. The recess surface 166 may be configured with one or more longitudinally extending corners 168. The fibrous preform may be bent around or over corner 136. The fibrous preform may be bent around or over corner 168. The female die 112 can be made of a graphite material or a machined carbon/carbon material suitable for withstanding elevated temperatures experienced during carbonization and densification processes.

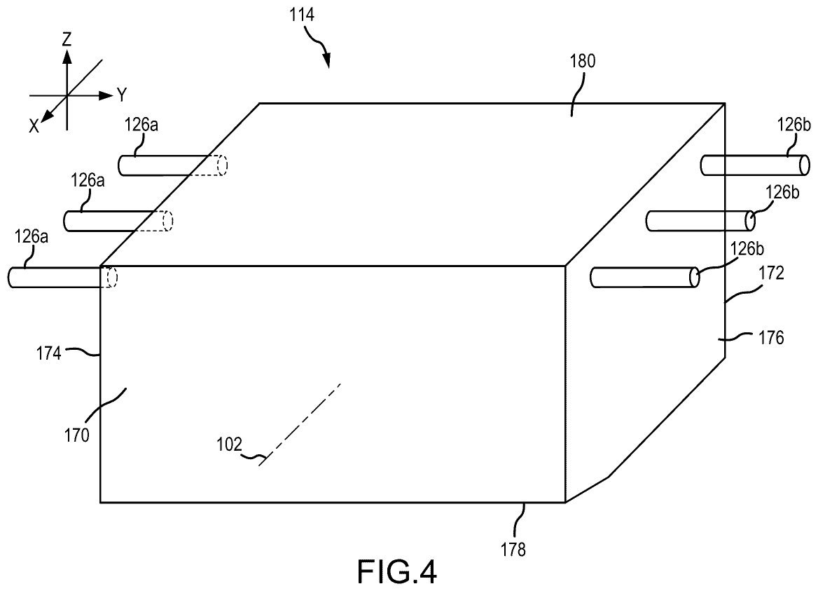

With reference to FIG. 4, the male die 114 extends longitudinally along a longitudinal centerline 102 of the male die 114 (e.g., along an X-axis) between and to a first end 170 of the male die 114 and a second end 172 of the male die 114. The male die 114 extends laterally (e.g., along a Y-axis) between and to a first side 174 of the male die 114 and a second side 176 of the male die 114. The male die 114 extends vertically (e.g., along a Z-axis) between and to a bottom side 178 of the male die 114 and a top side 180 of the male die 114. A profile of the male die 114 can be shaped and sized to conform to a geometry of the recess surface 166 of the female die 112. The male die 114 can be made of a graphite material or a machined carbon/carbon material suitable for withstanding elevated temperatures experienced during carbonization and densification processes.

The one or more alignment rods 126a can extend from the first side 174 of the male die 114. The one or more alignment rods 126b can extend from the second side 176 of the male die 114. The alignment rods 126 can be oriented parallel to the lateral direction (i.e., aligned with the Y-axis). The alignment rods 126 can be made of a graphite material or a machined carbon/carbon material suitable for withstanding elevated temperatures experienced during carbonization and densification processes.

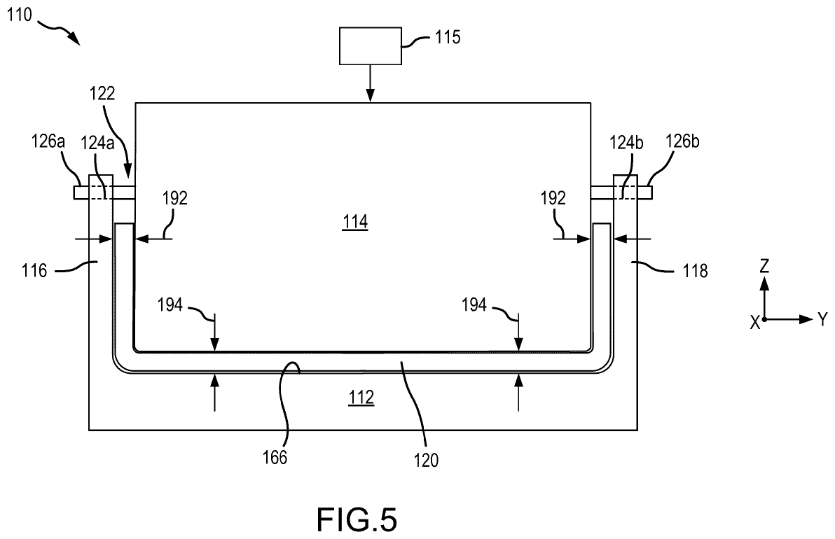

With reference to FIG. 5, the carbonization tooling fixture arrangement 110 is illustrated, viewed along the longitudinal axis, with a fibrous preform 120 installed therein, in accordance with various embodiments. With the male die 114 installed over the fibrous preform 120 and at least partially within the die recess 122 (e.g., see FIG. 1), the male die 114 may be moved (e.g., downward) vertically with respect to the female die 112 (see FIG. 2A and FIG. 2B). The male die 114 may be moved vertically under gravitational forces and/or using an apparatus 115, such as a dead weight, a press, or the like. As the male die 114 moves vertically to its (e.g., closed) position of FIG. 2B, the male die 114 transmits a compressing force to the fibrous preform 120. For example, compression forces (represented by arrows 192) can be transmitted between the sidewalls 116, 118 of the female die 112 and the side surfaces of the male die 114. Compressions forces (represented by arrows 194) can be transmitted between the bottom surface of the female die 112 and the bottom surface of the male die 114. As the male die 114 moves downward (i.e., in the negative Z-direction), the male die 114 moves longitudinally (i.e., in the negative X-direction).

In various embodiments, the fibrous preform 120 is made from a multi-layered preform; e.g., a stack of a plurality of layers of material. The fibrous preform 120 can be pre-formed in a separate tooling and then transferred to the carbonization tooling fixture arrangement 110 for carbonization. The fibrous preform 120 can be made of polyacrylonitrile (PAN) or OPF fibers extending in three directions and leaving a plurality of pores or open spaces and may be prepared for shape-forming, compression, and carbonization. In various embodiments, fibrous preform 120 is formed by stacking layers of PAN or OPF fibers and superimposing the layers (e.g., by stacking sheets of fabric). The layers may be needled perpendicularly to each other (i.e., along the Z-direction) with barbed, textile needles or barbless, structuring needles. In various embodiments, the layers are needled at an angle of between 0° and 60° (e.g., 0°, 30°, 45°, and/or) 60° with respect to the Z-direction to each other. The needling process generates a series of z-fibers through fibrous preform 120 that extend perpendicularly to the fibrous layers. The z-fibers are generated through the action of the needles pushing fibers from within the layer (x-y or in-plane) and reorienting them in the Z-direction (through-thickness). Needling of the fibrous preform may be done as one or more layers are added to the stack or may be done after the entire stack of layers is formed. The needles may also penetrate through only a portion of fibrous preform 120 or may penetrate through the entire fibrous preform 120. In addition, resins can be added, in various embodiments, to the fibrous preform 120 by either injecting the resin into the preform following construction or coating the fibers or layers prior to forming the fibrous preform 120. The needling process may take into account needling parameters optimized to maintain fiber orientation, minimize in-plane fiber damage, and maintain target interlaminar properties.

After needling the fibrous preform 120, the non-woven fibrous preform 120 may be both compressed to higher fiber volume and formed to shape in a shape-forming process. It should be understood, moreover, that fibrous preforms 120 not subject to needling prior to pre-carbonization compression are also within the scope of the present disclosure.

After the fibrous preform 120 is placed over the female die 112, the male die 114 is placed over the fibrous preform 120. In various embodiments, the fibrous preform 120 is pressed down into the die recess 122 (e.g., by hand or using a tool, such as the male die 114).

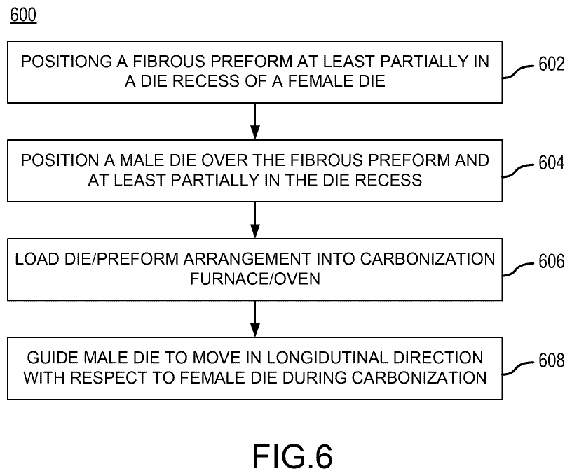

With reference to FIG. 6, a flow diagram of a method 600 for carbonization compression of an OPF preform 120 is provided, in accordance with various embodiments. For ease of description, the method 600 is described below with reference to FIG. 5. The method 600 of the present disclosure, however, is not limited to use of the exemplary carbonization tooling fixture arrangement of FIG. 5.

In step 602, the fibrous preform 120 is positioned with the female die 112 and at least partially in the die recess 122.

In step 604, the male die 114 is positioned over the fibrous preform 120 and at least partially in the die recess 122 of the female die 112. The bottom layer of the fibrous preform 120 may engage (e.g., contacts, is abutted against, lays flush on, etc.) the female die recess surface 166. The top layer of the fibrous preform 120 may engage (e.g., contacts, is abutted against, lays flush on, etc.) the male die 114.

In step 606, the fixtured fibrous preform 120 may be carbonized by placing the shape-formed fibrous preform 120 (i.e., the carbonization tooling fixture arrangement 110 together with the shaped fibrous preform 120) in a furnace with an inert atmosphere. The carbonization oven or furnace is turned on (i.e., heat is generated) to heat the fibrous preform 120 to a desired carbonization temperature. In various embodiments, the carbonization process involves heating the shape-formed fibrous preform 120 in a furnace to a temperature greater than about 1,200 degrees Celsius (2,912 Fahrenheit). The carbonization temperature may be between about 1,200 degrees Celsius (2,912 Fahrenheit) and about 2,400 degrees Celsius (4,352 Fahrenheit). In various embodiments, the carbonization process involves heating the shape-formed fibrous preform 120 in a furnace to a temperature greater than about 1,600 degrees Celsius (2,912 Fahrenheit). Typically, an inert atmosphere of nitrogen, argon or a vacuum is provided in the furnace during the carbonization process. The heat of the furnace causes a chemical conversion of the OPF that converts the fibers to carbon fibers and drives off other chemicals. Although it is sometimes preferred that the fibers in the carbonized fiber preform be 100% carbon fiber, it is generally acceptable for a less than full conversion to take place. The resulting carbonized fiber preform generally has the same fibrous structure as the fibrous preform before carbonizing. During carbonization, the total mass and the total fiber volume in each fibrous preform is typically reduced due to the loss of non-carbon compounds.

Fiber density of the fibrous preform 120 may increase during carbonization (e.g., from about 1.37 g/cc in OPF state to about 1.77-1.85 g/cc after carbonization, depending on the final carbonization temperature). In various embodiments, the OPF fibers shrink during carbonization, as OPF may have a char/carbon yield of around 50%. As used herein “char/carbon yield” means the remaining mass of the OPF after degrading the OPF using the carbonization process.

The carbonization tooling fixture arrangement 110 is configured to maintain compression on the fibrous preform 120 during the carbonization process. For example, fibrous preform 120 may be held in compression by placing a dead weight (e.g., apparatus 115) onto the male die 114 to evenly apply compressive forces onto the fibrous preform 120. In this manner, gravitational forces and the dead weight may hold the fibrous preform 120 in compression between the male die 114 and female die 112. Moreover, because the male die 114 is non-rigidly coupled to the female die 112, and gravitational forces pull the male die 114 toward the female die 112 (i.e., in the negative Z-direction in FIG. 5), the carbonization tooling fixture arrangement 110 is configured to accommodate shrinkage and further compression of the fibrous preform 120 during carbonization. In this regard, as the fibrous preform 120 shrinks during carbonization, the gap between male die 114 and the female die 112 may decrease due to the apparatus 115 (and/or gravity) biasing the male die 114 toward female die 112. In this manner, the shape of the fibrous preform 120 is maintained and the shrinkage of the fibrous preform 120 is further accommodated.

In step 608, the alignment rods 126 guide the male die 114 to move in the longitudinal direction and the Z-direction (also referred to herein as a second direction) with respect to the female die 112 during carbonization (e.g., as the fibrous preform 120 shrinks). For example, a first alignment rod 126a translates along, and is guided by, a first alignment surface 124a and a second alignment rod 126b translates along, and is guided by, a second alignment surface 124b. During the carbonization process the alignment rods 126 are in direct contact with female die 112. The alignment surfaces 124 can act as stops during the carbonization process to control the carbonized preform thickness and fiber volume to a target level. For example, with momentary reference to FIG. 2B, once the alignment rods 126 reach the bottom of the alignment surfaces 124, the male die 114 is blocked from moving any further in the negative Z-direction.

In various embodiments, the carbonization tooling fixture arrangement 110 can be designed such that the male die 114 sits up (i.e., proud of or protruding) above the female die 112 at the beginning of carbonization. During carbonization, the fibrous preform 120 will shrink (e.g., decrease in thickness). As this shrinkage is occurring, the influence of the apparatus 115 (or gravity) on the male die 114 will drive the male die 114 down and longitudinally to continue to apply pressure to the fibrous preform 120.

In various embodiments, apparatus 115 may additionally or alternatively comprise a hydraulic load (e.g., a hydraulic press). In this manner, a hydraulic load may be applied to bias the male die 114 toward the female die 112 during carbonization. As used herein, the term “external load” may refer to a dead weight and/or a hydraulic load.

The carbonization process may be employed to convert the fibers of the fibrous preform 120 into pure carbon fibers, as used herein only “pure carbon fibers” means carbon fibers comprised of at least 99% carbon. The carbonization process is distinguished from the densification process described below in that the densification process involves infiltrating the pores of the fibrous preform 120 and depositing a carbon matrix within and around the carbon fibers of the fibrous preform 120, and the carbonization process refers to the process of converting the fibers of the fibrous preform 120 into pure carbon fibers.

After carbonization, the carbonized fibrous preform 120 may be densified using chemical vapor infiltration (CVI), as described in further detail below. In various embodiments, the carbonized fibrous preform 120 is removed from carbonization tooling fixture arrangement 110 prior to densification. In various embodiments, the carbonized fibrous preform 120 is placed in a perforated graphite fixture during one or more densification runs. The carbonized fibrous preform 120 may be densified with pyrolytic carbon by CVI using optimized process conditions to maintain shape and support efficient carbon densification. In general, densification involves filling the voids, or pores, of the fibrous preform with additional carbon material. This may be done using the same furnace used for carbonization or a different furnace.

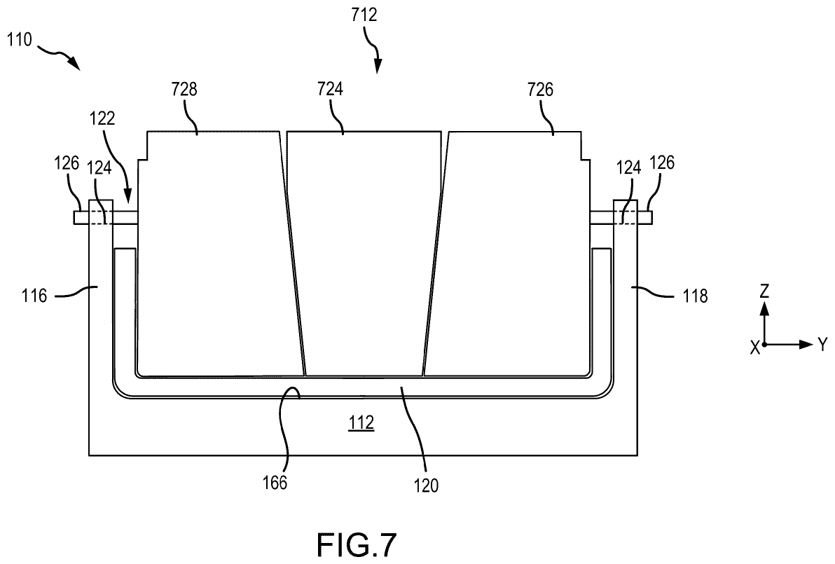

Having described the male die 114 as a single piece component, it is contemplated herein that the male die 114 could additionally or alternatively comprise a wedge and plug design, for example as described in U.S. Patent Publ. No. 2022/0402827, which is incorporated herein by reference. In such as design, the alignment rods 126a could be attached to a first plug and the alignment rods 126b could be attached to a second, opposing plug. For example, FIG. 7 illustrates a male die 712 comprising multi-piece wedge and plug arrangement comprising a wedge 724, a first plug 726, and a second plug 728. With respect to FIG. 7, elements with like element numbering, as depicted in FIG. 5, are intended to be the same and will not necessarily be repeated for the sake of clarity.

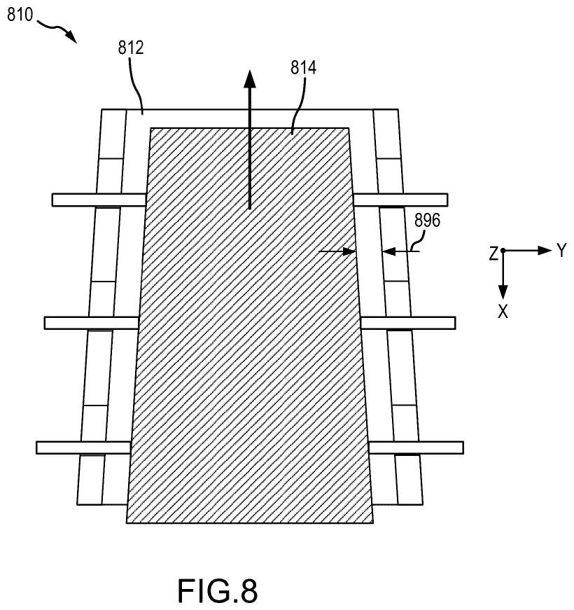

With reference to FIG. 8, a top view of a carbonization tooling fixture arrangement 810 is illustrated, in accordance with various embodiments. In various embodiments, the carbonization tooling fixture arrangement 810 is similar to the carbonization tooling fixture arrangement 110 of FIG. 1 through FIG. 5. The carbonization tooling fixture arrangement 810 includes a female die 812 and a male die 814. The carbonization tooling fixture arrangement 810 can have a tapered profile. More particularly, the carbonization tooling fixture arrangement 810 can be tapered along the longitudinal direction (i.e., along the X-axis). As the male die 814 translates in the longitudinal direction with respect to the female die 812 the gap 896 between the sidewalls of the female die 812 and the sides of the male die 814 can decrease. In this manner, the carbonization tooling fixture arrangement 810 can accommodate shrinkage of the sidewall portions of the fibrous preform during carbonization. In this manner, the carbonization tooling fixture arrangement 810 can maintain a desired compression force on the sidewall portions of the fibrous preform during carbonization.

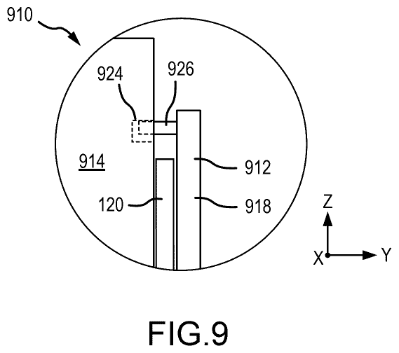

In various embodiments, it is contemplated herein that the alignment rods can be attached to the female tool and the alignment surfaces can be formed in the male tool (i.e., the alignment rods 126 and the alignment surfaces 124 can be swapped). With reference to FIG. 9, a portion of a carbonization tooling fixture arrangement 910 is schematically illustrated including a female tool 912 having a plurality of alignment rods 926 extending from the sidewall 918 thereof. The carbonization tooling fixture arrangement 910 further includes a male tool 914 having a plurality of alignment surfaces 924 disposed therein. The male tool 914 and the female tool 912 can be similar to the male tool 114 and the female tool 112, respectively, as described herein, except that the position of the alignment rods and the alignment surfaces are swapped.

The carbonization tooling fixture arrangements and their components are described above using the terms “bottom” and “top” with reference to exemplary orientations in the drawings. The present disclosure, however, is not limited to any particular formation system orientations. For example, in other embodiments, the male die 114 may alternatively be configured as a bottom die and the female die 112 may alternatively be configured as a top die.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for manufacturing a C/C part, the method comprising:
positioning a fibrous preform with a female die, the female die comprising a die recess extending longitudinally between and to a first end of the female die and a second end of the female die and extending laterally between and to a first sidewall of the female die and a second sidewall of the female die;
positioning a male die at least partially in the die recess so that the fibrous preform is positioned between the male die and the female die;
positioning a first alignment rod extending from a first side of the male die with respect to a first alignment surface of the female die;
positioning a second alignment rod extending from a second side of the male die with respect to a second alignment surface of the female die;
performing a heat treatment process on the fibrous preform while the fibrous preform is positioned between the male die and the female die; and
guiding the male die during the heat treatment process to move in a longitudinal direction and a second direction with respect to the female die using the first alignment rod and the first alignment surface and further using the second alignment rod and the second alignment surface, the second direction is perpendicular to the longitudinal direction and perpendicular to a lateral direction.

2. The method of claim 1, wherein the fibrous preform comprises an oxidized PAN fiber preform.

3. The method of claim 1, wherein the first alignment surface is disposed in the first sidewall of the female die and the second alignment surface is disposed in the second sidewall of the female die.

4. The method of claim 3, wherein the first alignment surface is disposed at a top side of the first sidewall and the second alignment surface is disposed at a top side of the second sidewall.

5. The method of claim 1, wherein the male die is configured to move simultaneously in both the longitudinal direction and the second direction in response to the first alignment rod moving along the first alignment surface.

6. The method of claim 1, wherein a first corner of the male die is aligned with a second corner of the female die in response to the first alignment rod moving along the first alignment surface.

7. The method of claim 6, wherein the die recess is at least partially defined by a first surface oriented at a non-parallel angle with respect to a second surface, the second corner of the female die is defined at an interface between the first surface and the second surface, and the second corner extends laterally between the first sidewall and the second sidewall.

8. The method of claim 1, further comprising decreasing a gap between the first sidewall and the male die in response to the male die moving in the longitudinal direction with respect to the female die, wherein the female die comprises a tapered geometry.

9. The method of claim 1, wherein the heat treatment process comprises a carbonization process.

10. A heat treatment tooling fixture arrangement, comprising:
a female die comprising a first sidewall, a second sidewall, a first alignment surface disposed in the first sidewall, a second alignment surface disposed in the second sidewall, and a die recess disposed between the first sidewall and the second sidewall;
a male die comprising a first alignment rod extending from a first side thereof and a second alignment rod extending from a second side thereof, the male die is configured to be received at least partially within the die recess; and
the first alignment rod is configured to contact, and move along, the first alignment surface and the second alignment rod is configured to contact, and move along, the second alignment surface to control movement of the male die along a first axis and along a second axis so as to apply a compressive force to a fibrous preform located between the male die and the female die during a heat treatment process.

11. The heat treatment tooling fixture arrangement of claim 10, wherein the first alignment surface and the second alignment surface are configured to control movement of the male die simultaneously along the first axis and along the second axis.

12. The heat treatment tooling fixture arrangement of claim 11, wherein the first alignment surface is disposed at a top side of the first sidewall and the second alignment surface is disposed at a top side of the second sidewall.

13. The heat treatment tooling fixture arrangement of claim 10, wherein a first corner of the male die is configured to move toward a second corner of the female die in response to the first alignment rod moving along the first alignment surface.

14. The heat treatment tooling fixture arrangement of claim 13, wherein the die recess is at least partially defined by a first surface oriented at a non-parallel angle with respect to a second surface, the second corner of the female die is defined at an interface between the first surface and the second surface, and the second corner extends laterally between the first sidewall and the second sidewall.

15. The heat treatment tooling fixture arrangement of claim 10, wherein the male die comprises a wedge, a first plug, and a second plug, the first alignment rod extends from the first plug, and the second alignment rod extends from the second plug.

16. The heat treatment tooling fixture arrangement of claim 10, wherein the female die and the male forming die each comprise a tapered geometry.

17. A method for controlling closed die tooling movement during heat treatment of a fibrous preform, the method comprising:
positioning a male die at least partially in a die recess of a female die, the die recess extending longitudinally between and to a first end of the female die and a second end of the female die and extending laterally between and to a first sidewall of the female die and a second sidewall of the female die;
positioning a first alignment rod extending from a first side of the male die in contact with a first alignment surface of the female die;
positioning a second alignment rod extending from a second side of the male die in contact with a second alignment surface of the female die; and
guiding the male die to move in a longitudinal direction and a second direction with respect to the female die using the first alignment rod and the first alignment surface and further using the second alignment rod and the second alignment surface.

18. The method of claim 17, further comprising applying a force to the male die in the second direction.

19. The method of claim 18, wherein the second direction is perpendicular to the longitudinal direction, the second direction is perpendicular to a lateral direction.

20. The method of claim 17, wherein the first alignment surface is oriented at a non-parallel angle with respect to the longitudinal direction.
